(19) United States
(12) Patent Application Publication
(10) Pub. No.: US 2012/0005025 A1
(43) Pub. Date: Jan. 5, 2012

(54) METHODOLOGIES AND SYSTEMS FOR ENHANCED CONTACT DIRECTORY-RELATED FUNCTIONALITY

(75) Inventors: Janne Aaltonen, Turku (FI); Sami Saru, Turku (FI); Mikko Kamarainen, Turku (FI); Christian Aminoff, Turku (FI)

(73) Assignee: Cvon Innovations Ltd., London Greater London (GB)

(21) Appl. No.: 13/002,418

(22) PCT Filed: Jul. 2, 2009
(86) PCT No.: PCT/EP2009/058372

§ 371 Date: Sep. 12, 2011

Related U.S. Application Data
(60) Provisional application No. 61/077,523, filed on Jul. 2, 2008.

(51) Int. Cl. G06Q 30/00

(52) U.S. Cl. 705/14.64; 705/400

(57) ABSTRACT

An enhanced contact directory application and associated enhanced contact directory for provisioning in a mobile device that enables the mobile device user to have access to information identifying the cost or likely cost of communicating with listed contacts via the mobile device prior to initiating communication with the contacts.

The invention relates in general to marketing and advertising campaigns directed to mobile device users. In particular the invention relates to methods, systems and software for providing enhanced contact directory-related functionality whereby mobile device users have access to information identifying the cost or likely cost of communication with listed contacts prior to initiating the communication, as specified in the preamble of the independent claims.

### BACKGROUND OF THE INVENTION

As more and more communication is initiated from mobile device users, so does the complexity and cost associated with various mobile services and service plans for consumers. Further, as more and more mobile devices, e.g., phones, smart phones, and Personal Data Assistants (PDAs), are manufactured and used by more and more consumers, the average consumer's ability to understand the cost of communicating with others via their mobile devices is decreased. This is particularly true when one takes into account that a mobile device user may be in their home network or roaming in another communication network.

As with any type of technology-implemented communication, there is a cost associated with the initiation and/or receipt of communication. In the case of mobile device implemented communication, the cost for communicating is generally born by the party initiating the communication (with the potential exception occurring when the party receiving the communication is roaming out of their home network). Thus, cost is an issue to understand and a concern to manage for mobile device users.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with illustrated embodiments, an enhanced contact directory for provisioning in a mobile device that enables the mobile device user to have access to information identifying the cost or likely cost of communicating with listed contacts prior to initiating communication with the contacts, as indicated in the independent claims of the present application. This is achieved by a combination of features recited in each independent claim. Accordingly, dependent claims prescribe further detailed implementations of the present invention.

### BRIEF DESCRIPTION OF THE DRAWINGS

A more compete understanding of the present invention and the utility thereof may be acquired by referring to the following description in consideration of the accompanying drawings, in which like reference numbers indicate like features, and wherein:

FIG. 1 illustrates an environment wherein embodiments of the invention may be utilized.

FIG. 2 illustrates additional details included in an Advertisement Management System (AMS) provided in accordance with at least one illustrated embodiment.

FIG. 3 illustrates additional details included in a Universal Charging System (UCS) provided in accordance with at least one illustrated embodiment.

FIG. 4 illustrates various components of a mobile device wherein an enhanced contact directory in accordance with at least one illustrated embodiment may be utilized.

FIG. 5 illustrates one example of an enhanced contact directory provided in accordance with at least one illustrated embodiment.

FIG. 6 illustrates another example of an enhanced contact directory provided in accordance with at least one illustrated embodiment.

FIG. 7 illustrates various operations performed in accordance with updating an enhanced contact directory in conjunction with a promotional campaign in accordance with at least one illustrated embodiment.

FIG. 8 illustrates various environmental components wherein embodiments of the invention may be utilized.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in the respect.

Mobile device users pay for communicating via their mobile device or that communication is paid for on their behalf (for example, a mobile phone used for business calls while a user is travelling may often be paid for by the user's employer). Such mobile services are often packaged in different ways as plans or are available on an individual use basis. As a result, costs are variable and dynamic.

Thus, there are various different data, voice and messaging plans available for mobile device users to use various services offered by mobile networks. For example, there may be voice-only plans with one price level during evenings and a higher cost per minute during the day time. Likewise, weekends might have unlimited minutes. Additionally, there are mobile service subscriptions with different prices depending if the calling party is calling another subscriber in the same mobile network or parties in other networks. Additionally, there are mobile service subscriptions that allow callers to place calls to individuals in a limited group of identified users (e.g., friends and/or family) for a lower price or at no cost. Furthermore, pricing and price reductions may differ if the caller is roaming or if the recipient of the call is roaming out of their home network.

Additionally, various different types of mobile services, e.g., voice, texts and video calls can be bundled together with limitations on the timing or amount of services provided to the mobile service subscriber. Some subscription plans are time-based (e.g., number of minutes available), some data-based (e.g., voice not SMS), some plans may include fixed amounts of data (e.g., a specified amount of memory) and, once that amount of data is exceeded then per kilobit pricing thereafter. Furthermore, some subscription plans offer unlimited minutes or data over a specified period of time.

Payment for mobile services may be as a “post-paid subscription,” i.e., a mobile subscription that is billed on a periodic basis following use of the mobile service, or “pre-paid subscription,” wherein, the subscriber pays for services before the services are used.

Additionally, some mobile service providers have introduced service-specific data plans where certain destination addresses (for example, an Internet Protocol (IP) address) are free or discounted or access of some of the services is free or discounted or priced in different ways.

Further, some mobile service providers offer incentives for consumers to be exposed to mobile marketing or advertising material or campaigns. As more and more communication is initiated from mobile device users, so does the potential impact, capability and efficacy of marketing and advertising to those users through their mobile devices. Such promotional activities, also known as “mobile marketing,” involve and relate to marketing and advertising via mobile devices, e.g., phones, smart phones, and Personal Data Assistants (PDAs), receiving promotional material, i.e., marketing and/or advertising content in the form of, e.g., text, audio, video or some combination thereof associated with a particular product, service or combination thereof.

Mobile marketing enables advertisers to directly reach individual consumers in a targeted way. This is because the nature of mobile media is personal, in that mobile devices are generally used by a particular individual rather than a group of individuals. Further, mobile media is, by definition, mobile, which offers a transportable mechanism for exposing potential consumers to promotional material. Moreover, because mobile media is “always on,” advertisers are not constrained by the need to make a connection in order to deliver promotional material to a user's device because a connection is always established with a user's mobile device (provided the mobile device is in range of an available communication network).

As an additional benefit of mobile media as an advertising mechanism, mobile media enables groups of individuals to form wherein the group members communicate actively with each other. As a result, these characteristics combined with social networks-based marketing approach of the Internet may form a very powerful base to execute marketing strategies.

However, there are various costs associated with mobile marketing, including, for example, the costs associated with formulation and delivery of a direct advertisement message to a targeted individual (i.e., someone who has the attributes identified in an advertising campaign) by direct marketing, or media space in brand advertising. Therefore, an advertiser may limit the amount, type or frequency of promotional material sent to mobile users. Accordingly, advertisers are interested in obtaining a maximized amount of impact on mobile users with a minimized amount of cost.

Likewise, as with any type of technology-implemented communication, there is a cost associated with the initiation and/or receipt of communication. In the case of mobile communication, the cost for communicating is generally born by the party initiating the communication (with the potential exception occurring when the party receiving the communication is roaming out of their home network). Thus, cost is an issue and concern for advertisers and mobile device users alike.

Therefore, some mobile service providers offer incentives for consumerts to opt into mobile advertisement-based free or subsidized service costs wherein a subscriber agrees to be exposed to promotional material via their mobile device in exchange for lower priced and/or free mobile services, be it voice, text, video, data, applications etc. For example, a mobile service provider may offer a specified amount of wireless call minutes in exchange for a mobile service subscriber agreeing to receive a certain number of advertisements each month on their mobile device. Further, some service providers may promote their communication network(s) by offering free or subsidized communication between (registered) friends or between an individual and person(s) who he has been able to recruit to a network. Similarly, as explained herein advertisers may be willing to subsidize/sponsor communication between their customers (e.g., between mobile device users registered with one or more advertising/marketing campaigns), as explained herein.

In general, mobile marketing and advertising activities can be divided into four categories: mobile Customer Relation Management (CRM), mobile marketing, mobile advertising, and mobile direct advertising. Mobile CRM involves a combination mobile advertising, mobile marketing and mobile direct marking (each explained herein) in a manner that establishes a long-term, engaging relationship between the customer and the promoting company.

Mobile marketing involves the systematic planning, implementation and control of a mix of business activities intended to bring together buyers and sellers for the mutually advantageous exchange or transfer of products or services where the primary point of contact with the potential consumer is via their mobile device. To the contrary, mobile advertising may be thought of more narrowly as the paid, public, non-personal announcement of a persuasive message by an identified sponsor (i.e., advertiser), the non-personal presentation or promotion by a firm of its products to its existing and potential customers where such communication is delivered to a mobile phone or other mobile device. Examples of mobile advertising would include: Wireless Application Protocol (WAP) banner advertisements, mobile search advertising, mobile video bumpers, and interstitial advertisements.

Mobile direct marketing differs from mobile marketing typically in that direct marketing involves promotional material being delivered to a mobile device on an individual basis. Accordingly, examples of mobile direct marketing include the sending of Short Messaging Service (SMS), Multimedia Messaging Service (MMS) or WAP push messages, Bluetooth messaging and other interrupt-based marketing to mobile devices. Such direct marketing often uses text and picture messaging.

As the options and complexities of mobile data and voice plans continue to increase, subscribers find it difficult to understand how much of their allocated mobile network service resources (e.g., voice, messaging, data, video, audio, applications etc) they have left or how much usage of network resources costs for them for each type of communication initiated via their mobile device. Additionally, the subscribers do not have access to information that indicates how that amount of resources may be expended at different rates from service to service or from communication recipient to communication recipient.

Conventionally, subscribers could check a remaining or cumulative balance for their wireless services by sending a text message such as “My account” to some a number defined by the mobile service provider, e.g., “16400.” In response to this inquiry, the mobile service provider would issue a text message with the amount of money left in the subscriber's account (e.g., pre-paid subscription), used minutes or minutes left in account (e.g., post-paid subscription), etc. However, particularly in the case of post-paid subscriptions, the ability to reliably determine the remaining minutes available under a plan is difficult or impossible due to mobile service provider's inability to known when, from where and to where the subscriber might be communicating next and using what type of communication (e.g., voice, text, video, etc.).

Thus, in accordance with at least one illustrated embodiment, functionality and methodologies are provided that enable the mobile device user to have access to information indicating the cost or likely cost of communicating with individuals listed in their contact directory prior to initiating communication with those contacts. That information may be provided in an enhanced contact directory, e.g., a directory of contact information including phone numbers and/or electronic mail addresses, network IDs (e.g., Skype™ or Facebook™ ID), etc., which is included in the subscriber's mobile device. Therefore, in accordance with at least one illustrated embodiment, information indicating how much mobile service network resources a communication, e.g., voice call, from the subscriber to a listed contact will or is likely to require is provided in the subscriber's mobile device's contact directory.

Because of the complexity of service plans with different pricing using different mobile service providers, such an enhanced contact directory provides an indication of the implications of initiating communication with another specified party via one or more different communication modes (e.g., voice, text, video, messaging, email, etc.). Thus, in accordance with at least one illustrated embodiment, mobile device users may have access to information indicating the amount of mobile service plan resources that will or will likely be expended to communicate from the mobile device to someone listed in their contact directory.

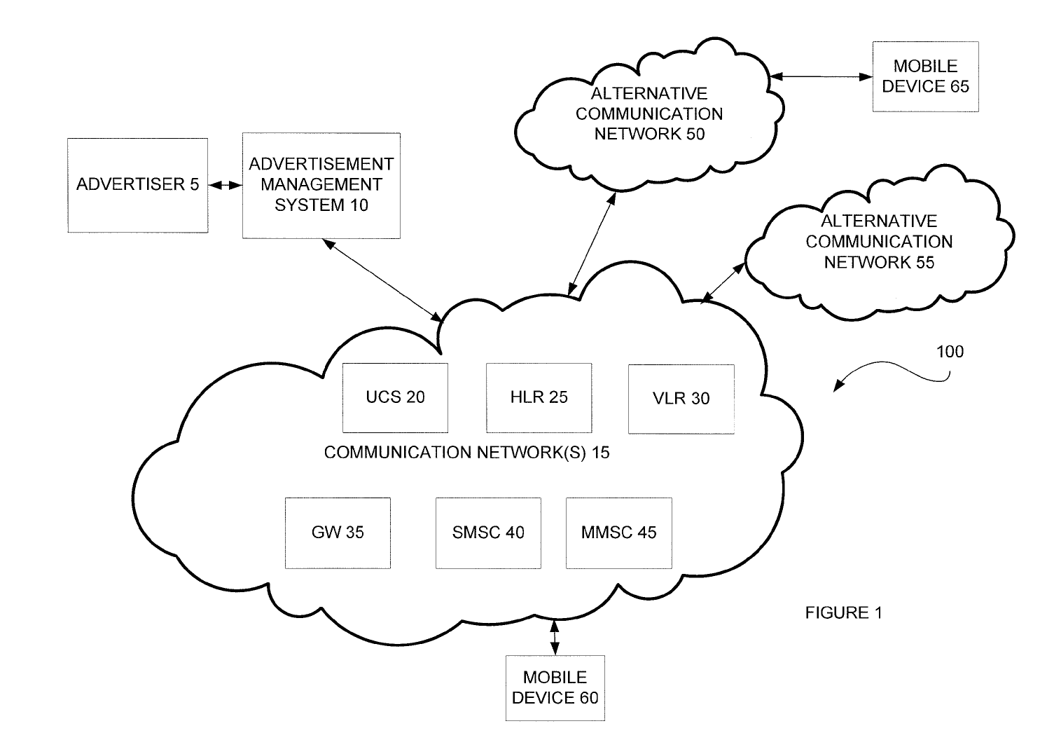

FIG. 1 illustrates one example of an environment in which mobile services may be provided to a plurality of mobile devices and illustrated embodiments may have utility. As shown in FIG. 1, the environment includes a plurality of networks 15, 50, 55 available for providing communication in various modes (e.g., voice, text, video call, messaging, email, etc.) for and between mobile devices 60, 65 (as well as between those mobile devices 60, 65 and other devices such as Public Switched Telephone Network (PSTN) telephones, desktop computers, etc. not shown).

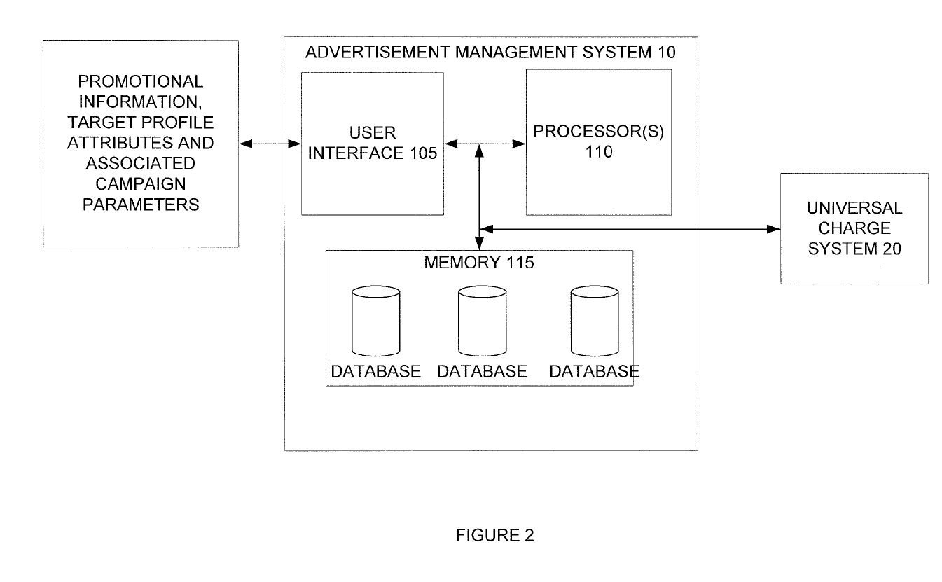

Moreover, as explained herein with reference to FIGS. 2-3 and 7, some or all of the communication initiated by mobile devices 60, 65 may be subsidized or paid for by one or more advertisers 5 utilizing the Advertisement Management System (AMS) 10 in cooperation with the Universal Charging System (UCS) 20.

Thus, one or more communication networks 15 may include a UCS 20, Home Location Register (HLR) 25, and Visiting Location Register (VLR) 30.

The HLR 25 may be configured to monitor and control operations in connection with the location of subscribers' mobile devices in order to route communication appropriately, e.g., when the communication is a mobile call, to route that call to the appropriate cellular base station (not shown). Likewise, the VLR 30 is configured to monitor visitors in the at least one communication network 15 from other communication networks and assist in performing routing of their communication, e.g., voice calls, text messages, e-mails, etc.

The one or more communication networks 15 may further include one or more cellular base stations (not shown), which are wireless communications station installed at a fixed location and used to communicate as part of either a push-to-talk two-way radio system or a wireless telephone system.

For example, the one or more communication networks 15 may include any type of communications network and network components including but not limited to second Generation (2G) networks, 2.5 Generation networks, third Generation (3G) networks and networks utilizing Global System for Mobile Communications (GSM), Wideband Code Division Multiplex Access (WCDMA), Code Division Multiplex Access (CDMA), or Time Division Multiplex Access (TDMA), General Packet Radio Services (GPRS), and Universal Mobile Telephone System (UMTS). Further, the one or more communication networks 15 may also include local area networks, such as Wireless Local Area Networks (WLAN), BlueTooth (BT) and optionally utilize one or more other technologies, such as WiMax (WorldwideInteroperability for Microwave Access).

Communication via the one or more communication networks 15 may be implemented by broadcasting over cellular, broadcasting over DVB-H (Digital Video Broadcasting—Handhelds), ISDB-T (Terrestrial Integrated Services Digital Broadcasting) or DMB (Digital Multimedia Broadcasting). Further, optionally, MediaFlo™ may be used to provide a connection and to deliver a service. The one or more communication networks 15 can also include any other type of network of interconnected devices or device networks, e.g., interconnected computers or computer networks. Accordingly, it should be understood that the one or more communication networks 15 can also be a combination of a plurality of different types of networks forming one or more hybrid networks.

Thus, the communication network(s) 15 may include one or more GateWays (GWs) 35 configured to enable connection to the Internet or other services, as well as Short Message Service Centers (SMSCs) 40 and Multimedia Message Service Centers (MMSCs) 45. Accordingly, the one or more communication networks 15 may enable transmission of SMS and MMS messages.

As also illustrated in FIG. 1, an advertiser 5 (which may be an advertiser, advertising firm, media agency, consultancy company or other similar entity interested in determining a marketing or advertising campaign's efficacy) may access the advertisement management system AMS 10 (illustrated in further detail in FIG. 2) in order to manage and control distribution of promotional material in connection with one or more marketing or advertising campaigns via the one or more communication networks 15.

Thus, the AMS 10 may be operationally coupled to GateWay (GW) 35, which can be used to execute the campaign and deliver information about the campaign back to the AMS 10. As such, the GW 35 may be implemented in whole or in part using one or more intermediate servers between the advertisement management system 10 or with the system 10 and the one or more communication networks 15. Alternatively, the GW 35 may be implemented in combination with the advertisement management system 10.

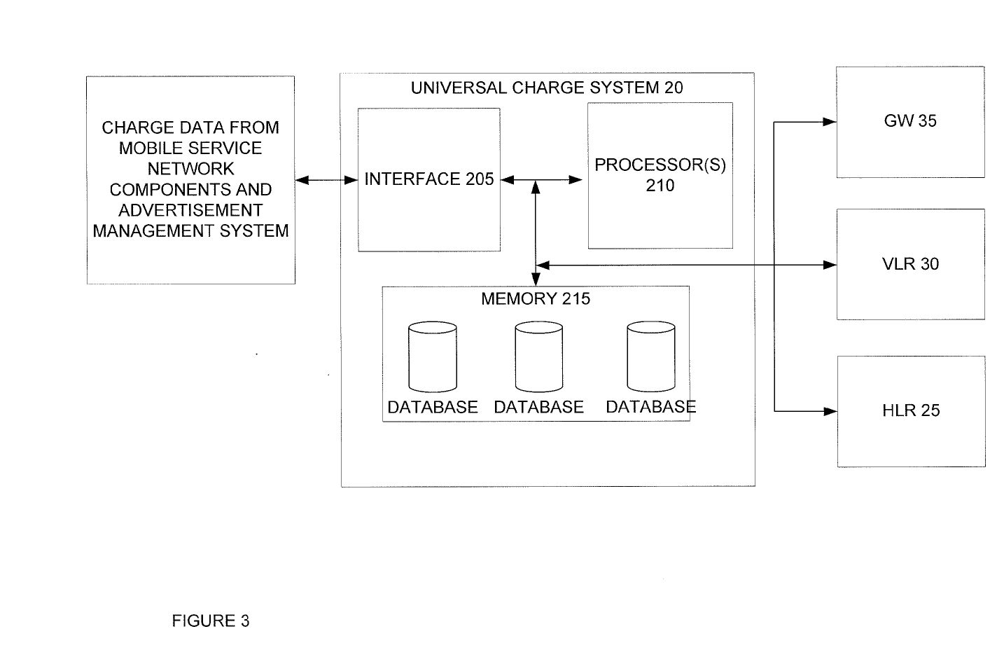

Further, the AMS 10 may be in communication with and coupled to the UCS 20 (explained in more detail in connection with FIG. 3) is configured to administer and control pricing and usage of resources provided by the at least one communication networks 15 by subscribers to mobile services provided via the networks 15.

Mobile service providers utilize and/or operate the communication network(s). Thus, the term “mobile service providers” encompasses, for example, mobile network operators, carriers and other parties utilizing the communication networks to deliver mobile services to subscribers. The networks 15 utilized and/or operated by the mobile service providers can be connected or coupled to other alternative communication networks 50, 55 that may be utilized or operated by the same or different mobile service providers as those associated with the communication network(s) 15. Thus, the alternative communication networks 50, 55 may each have similar constituent components as those illustrated in FIG. 1 in connection with communication network(s) 15.

In provisioning of mobile services to a subscriber using mobile device 60, the communication network(s) 15 utilize the constituent components of 20-45, to provide communication with the mobile device 65 through cooperation with the alternative communication network 50. The mobile devices 60, 65 may each be, for example, a mobile phone, PDA, smart phone, laptop, etc. or any other type of user equipment that can be used to connect to a mobile network.

For the purposes of administering mobile communication, the mobile device 60 is said to be in the home network if it is used in the network that is operated or controlled by its mobile services provider (i.e., the party that the consumer has made subscription with provide mobile services, for example communication network(s) 15 for mobile device 60 or communication network 50 for mobile device 65. Likewise, the mobile device is said to be roaming when it is used in a network other than the mobile device's home network, e.g., if mobile device 65 were being used in communication network 55.

FIG. 2 illustrates the AMS 10 in more detail. In accordance with an illustrated embodiment, the AMS 10 is configured to manage and distribute promotional material via the one or more networks 15 to mobile device users and others. Thus preferences, settings, promotional material, advertisement content, advertisements, messages, texts, figures, keywords and/or other rules of sending and tagging communication transmitted via the one or more communication networks 15 may be stored in memory 115.

Accordingly, an advertiser 5 may use the user interface 105 to provide promotional material and data indicating how promotional material is to be distributed (e.g., the content and format of the advertisement content) in connection with a marketing and/or advertising campaign. Thus, the user interface may be implemented as a portal or website on the Internet, as an Application Protocol Interface (API) program, etc. Once the promotional information and distribution information is received via the interface 105, it may be stored in one or more databases included in memory 115 for subsequent use by processors 210 running software for directing and controlling the delivery promotional information via the mobile network(s) (15 illustrated in FIG. 1) to one or more mobile device users (60, 65 illustrated in FIG. 1).

In an illustrated embodiment, advertisers (e.g., advertiser 5 illustrated in FIG. 1) may also agree to sponsor some portion of a mobile device user's communication in return for receiving advertising and/or promotional information on their mobile devices, e.g., for mobile advertising purposes. Accordingly, although not illustrated or discussed herein, it should be understood that an advertising management system (such as AMS 10 illustrated in FIG. 1) may operate and cooperate with the a charging system (such as UCS 20 illustrated in FIG. 1) to control transmission of advertising and/or promotional information to mobile devices receiving free or subsidized communication.

Moreover, in an illustrated embodiment, a mobile device subscriber may agree to incorporate advertising and/or promotional material in their communications with contacts listed in their enhanced contact directory in return for free or subsidized communication with those contacts. As a result, an indication of the free or subsidized nature of that contact's communication may be included in the enhanced contact directory. For example, a mobile device user may share a common interest with a contact listed in their enhanced contact directory, e.g., video games; thus, the mobile device user may agree to have communication with that contact include advertising regarding video games.

Accordingly, it should be understood that various types of information including mobile service subscriber identification information may be accessible through and/or used by the AMS 10 to provide tailored advertising material for delivery to mobile devices. Further, mobile subscriber profile attributes, including but not limited to various interest and demographic information may also be accessible through and/or used by the AMS 10.

As illustrated in FIG. 2, the AMS 10 may include one or more processors 110 operationally coupled to a user interface 105, computer readable memory and/or other data storage 115. Accordingly, computer executable instructions and data used by the processor(s) 110 and other components within the AMS 10 may be stored in the computer readable memory included the AMS 10. Further, software may be stored within the memory and/or storage 115 (coupled to the processor(s) 110 and user interface 105) to provide instructions to the AMS components for enabling the system 10 to perform various functions.

For example, the AMS 10 may be configured to receive promotional material and/or profile attributes associated with marketing and/or advertising campaigns as well as other details regarding distribution of such promotional material via the user interface 105. Subsequently that information may be stored in one or more databases included in the computer readable memory and/or other data storage 115. Accordingly, the user interface 105 may be configured to enable an advertiser 10 or other entity to interact with components of the AMS 10 as well as other systems coupled to the system 10 such as GW 35, SMSC 40 and MMSC 45 to manage and control distribution of promotional material as part of one or more marketing or advertising campaigns. Accordingly, the user interface 105 may be implemented as a web-based user interface provided by software stored in the memory 115 or running on one or more servers associated with or supporting the AMS 10.

The memory 115 may include one or more databases configured to store individual-specific profile information indicating which and to whom communication is subsidized or free as well as associated information, such as the type and quantity of promotional material mobile subscribers have agreed to receive or include in their communications. Additionally, memory 115 may include mobile subscriber profile information including an individual's age, gender, zip code, food preferences, music preferences, movie preferences, etc. Further, memory 115 may include additional databases for storing promotional material archive information, which may indicate what promotional material has been sent to specific individuals in the past, the type of promotional material (e.g., SMS, couponing, text-to-win campaign material) and the individuals' responses to the promotional material. Additionally, the memory 115 may also include one or more databases for storing actual promotional material and related distribution parameters for use in distributing the promotional material in connection with campaigns.

It should be understood that memory 115 may include many databases that separately include, for example, profile attribute information, promotional material, archive data, etc. or some combination or all of this information and data may be included in a single database.

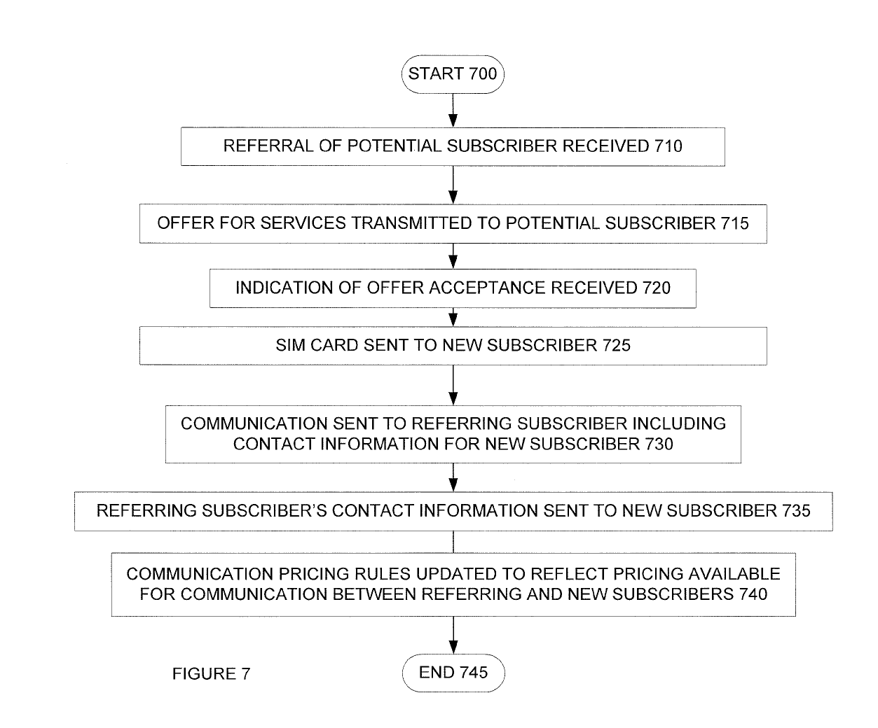

As illustrated in FIG. 3, the UCS 20 may similarly include an interface 205 for sending and receiving data from both the AMS 10 and also mobile services providers associated with the one or more networks 15. That information is stored in one or more databases in a memory 215 for use by processor(s) 210 for managing call data so as to monitor and process communication via the network(s) 15, for setting and following rules for charging for communication via the network(s) and for distribution of promotional material via the network(s) 15. For example, the databases of memory 214 may include pricing rules on how to price various modes of communication (e.g., voice, text, videophone, e-mail, etc.) in the network(s) 15 and out of the network(s) 15. The memory 215 may also include pricing rules on whom should be charged for various types of communication when a subscriber is, for example, roaming or communicating with called parties in special groups, promotions or with special services (explained in more detail below with reference to FIG. 7).

Such pricing rules may be general across a network(s) or personal, and thereby limited to a particular subscriber or group of subscribers. Further, as explained in more detail below, pricing rules may be dynamic, adjustable and/or controllable by one or more advertisers 5, for example, via the advertisement management system 10, thereby enabling the advertiser to set pricing rules for subscribers and between subscribers to mobile services provided via the communication networks(s) 15.

Additionally, the UCS 20 may be coupled to or interact with the HLR 25, VLR 30 and/or GW 35 to control and/or enable communication via the communication network(s) 15 based on the pricing rules stored in the memory 215.

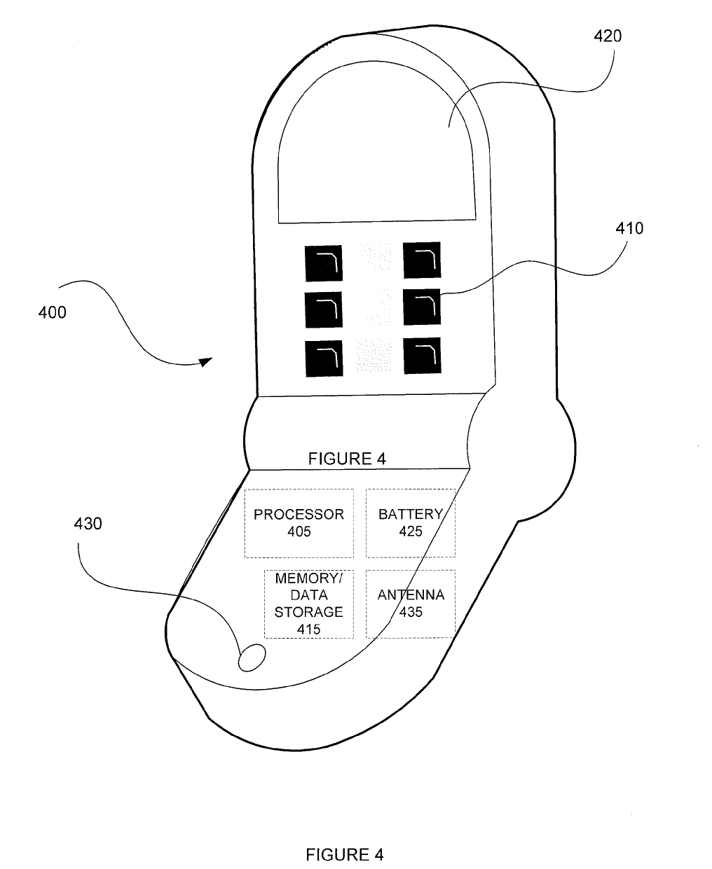

Returning to the features of mobile devices that may be running an enhanced contact directory (such as the mobile devices 60, 65 of FIG. 1), such mobile devices can be implemented as a mobile phone, lap top, PDA, multimedia computer, etc. Accordingly, as illustrated in FIG. 4, it should be understood that such mobile devices 400 may include a processor 405 connected to a user interface 410, computer readable memory and/or other data storage 415 and a display 420 (which may or may not be considered part of the user interface 410). The mobile devices 400 may also include a battery 425, speaker 430 and at least one antenna 435. The user interface 410 may further include a keypad, touch screen, voice interface, one or more arrow keys, joy-stick, data glove, mouse, roller ball, touch screen or the like.

Accordingly, computer executable instructions and data 440 used by the processor 405 included in a mobile device 400 and other components within the mobile device 400 may be stored in the computer readable memory 415 included the mobile device. Further, the memory 415 may be implemented with any combination of read only memory modules or random access memory modules, optionally including both volatile and nonvolatile memory. Further, software 445 may be stored within the memory and/or storage 415 to provide instructions to the mobile device's processor for enabling the mobile device to perform various functions. Alternatively, some or all of the mobile device computer executable instructions may be embodied in hardware or firmware (not illustrated).

Accordingly, a portion or all of an enhanced contact directory software application may be provided in the memory 415 of the device 400 to provide the enhanced contact directory functionality of the illustrated embodiments. Thus, the mobile device 400 may have the enhanced contact directory embedded as a “native” application in the software 445 in the mobile device. Alternatively, or in addition, the application or certain application functionality may be provided via downloadable applications for managing the phone directory.

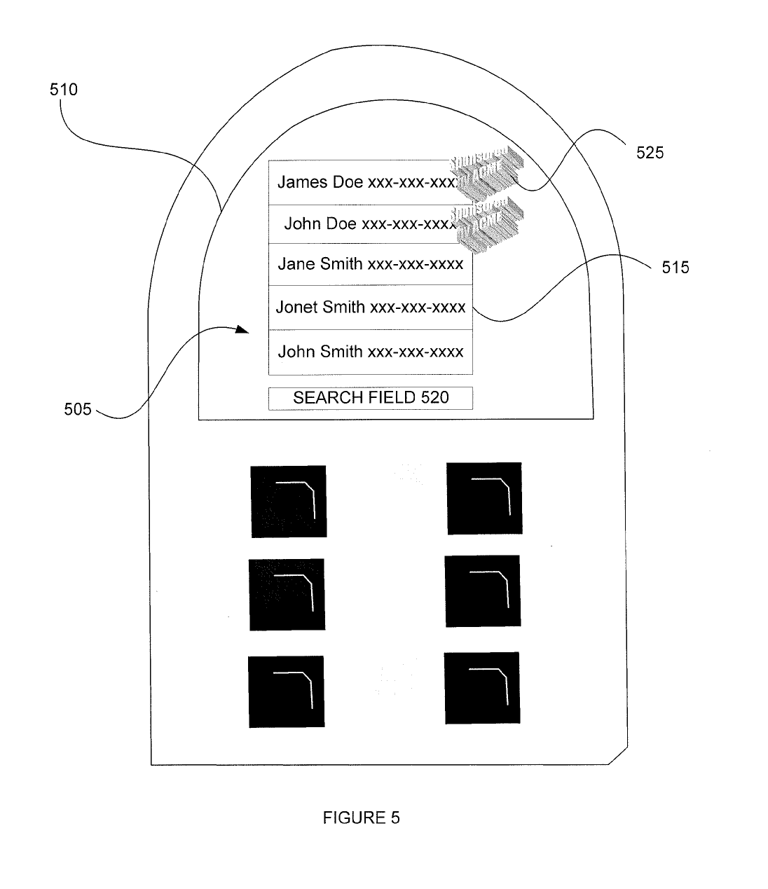

FIG. 5 illustrates one example of the enhance contact directory provided by an illustrated embodiment. As shown in FIG. 5, a list of contacts 505 may be provided on display 510 and include a list of contact entries 515 displayed in various optional orders, e.g., alphabetical order or in some other order as most called, last called, missed phone calls etc. Additionally, or alternatively, the contact entries 515 may be listed in some type of order based on the price of communicating with the contact, e.g., by voice call or some other mode of communication. For example, those contacts with which the subscriber may communicate at no cost may be listed first with the order of the contacts being based on price of communicating with them. Furthermore, the order of the contacts may be changed at the option of the subscriber based on a list of options included in the enhanced contact directory.

As an additional and/or optional feature, the enhanced contact directory application may also provide the feature of enabling the subscriber to search the directory by inputting text into a search field 520. Further, each contact entry 515 may also include or be associated with a displayed graphic(s) or icon(s) 525 corresponding to the contact entry 515 (or a communication mode in the contact entry, particular contact information in the contact entry, e.g., work phone number versus home phone number). In an illustrated embodiment, the graphic(s) or icon(s) 525 may serve as an indicator of the cost of communicating with the contact or the sponsor of the communication with the contact (as explained below, where in one potential implementation, advertisers may subsidize or sponsor the entire cost of the communication).

As a further option, the graphic(s) or icon(s) 525 may indicate the actual minute price per phone call or remaining communication (e.g., minutes of talk time in a mobile voice call) available to that contact under the subscriber's mobile services plan. It should be appreciated, however, that cost data like the actual cost of communicating with a contact may be dynamic; for example, the cost of communicating with a contact may change based on the time of day of the communication, day of the week of the communication, or location of the party initiating the communication. Thus, the cost data may also include an indication of the period of time that the cost is valid and, optionally, the cost subsequent to that period.

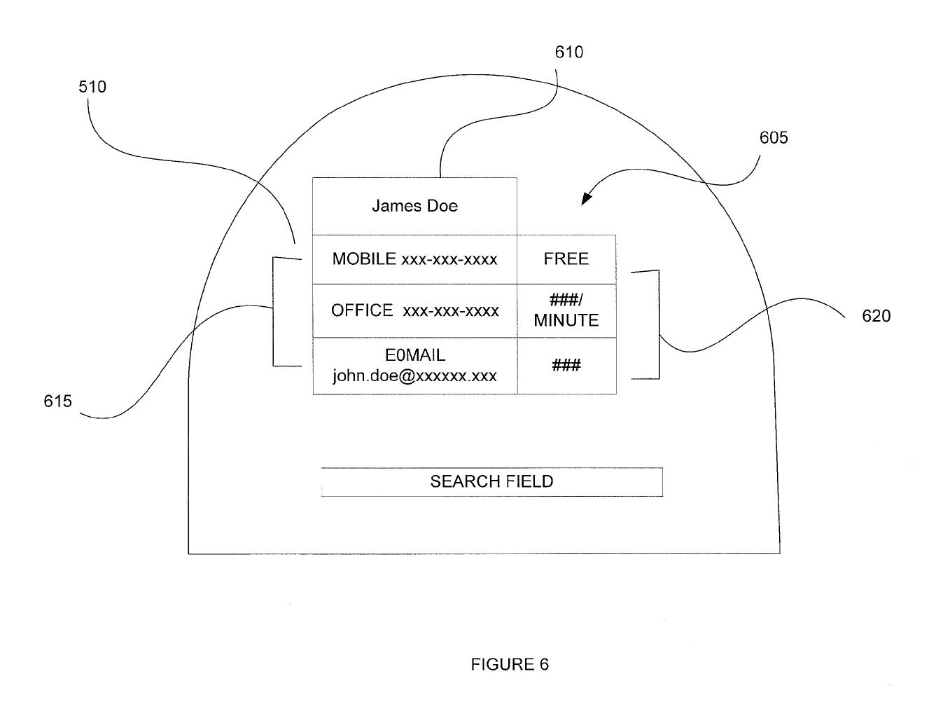

Additionally, as a further level of detail optionally available in the enhanced contact directory, the price for communicating the contact via various communication modes may also be included in the contact entry, an example of which being illustrated in FIG. 6. Thus, an enhanced contact entry 605 may include the contact information 615 associated with the contact identification 610 and associated cost data 620 indicating the cost for communicating with the contact via each of the communication modes (e.g., voice, text, videophone, email, messaging, etc.) for which there is contact information 615.

Alternatively, pricing information may be limited to the mode in which the subscriber is operating at the given time. For example, if the subscriber is in the process of sending a text message, i.e., using the SMS messaging mode of the mobile device, the enhanced contact directory presented to the subscriber in connection with formulating that text message may only include cost data associated with SMS messaging the contact.

Information included in the enhanced contact directory may be updated in a variety of operations. For example, the subscriber himself may enter additional contact information 615 for an existing contact entry 605 as that information is learned by the subscriber. However, the updating of cost data and associated graphics or icons and related functionality may be updated under the control of or in cooperation with the UCS 20 (illustrated in FIGS. 1 and 3) in various ways as explained herein.

At the outset of this explanation, it should be appreciated by one of ordinary skill in the art that the pricing information provided to mobile device users in the enhanced contact directory may be formulated in a number of different and suitable ways. Additionally, the pricing information may actually include an estimate of the cost of communicating with a contact because, in some situations, the actual cost of communication may be dynamic and not fully verifiable or updateable on a real-time or near real time basis. Thus, estimated cost or price may be predicted or formulated based on call histories and pricing information available to the mobile service providers and may be implemented for example by collecting average call durations from a user to a contact. Alternatively, some communication costs, for example, the cost of communication may be easily determined when a subscriber is communicating with a contact via a voice call communication mode when the called party is in the same network as the subscriber.

Nevertheless, when provisioning the enhanced contact directory application on a subscriber's mobile device, it should be appreciated that there are various ways to determine the pricing information for the contacts included in the subscriber's non-enhanced contact directory. Thus, for example, when the subscriber has a relatively small number of contacts, e.g., less than thirty, the determination of pricing information may be performed in a batch format wherein all of the contact directory entries are analyzed to determine communication pricing information.

Alternatively, when a subscriber has a relatively large number of contacts, e.g., more then one hundred, the communication pricing information may be formulated on a “one-off” basis, wherein the communication pricing information for a particular contact is formulated when that contact is first communicated with after provisioning of the enhanced contact directory application. Therefore, as the subscriber communicates with his contacts, the enhanced contact directory may be updated to include pricing information. Moreover, if a particular contact entry includes contact information for more than one communication mode (e.g., voice call, messaging, videophone, e-mail, etc.), the communication pricing information may be formulated when that communication mode is first used for that contact.

This one-off approach to providing communication pricing information for inclusion in the enhanced contact directory may be more cost effective and easier to implement than a batch approach while still providing valuable functionality to subscribers. For example, if a subscriber uses mobile device (e.g., a PDA) to store a large and varied quantity of information about each contact listed in the contact directory (e.g., work phone numbers, electronic mail addresses, facsimile transmission numbers, mobile phone numbers, home phone numbers, etc.), but rarely if ever uses the PDA to, for example, communicate with listed contacts at their facsimile transmission numbers), then there is relatively little utility provided to the subscriber to include communication pricing information regarding the cost of faxing that particular contact using the mobile device.

It should also be appreciated that contact communication pricing information may also be updated or augmented in the enhanced contact directory each time or from time to time when the subscriber communicates with the contact. Thus, the communication pricing information may be updated as mobile service rates change or something affecting the cost of communicating with a contact changes, e.g., the contact has maintained their mobile telephone number but switched to a different mobile services provider (e.g., network operator).

As a further example of a mechanism for updating the enhanced contact directory with communication pricing information, consider the scenario where a mobile services provider is interested in attracting new subscribers. Accordingly, the mobile services provider offers a referral marketing campaign offering free or subsidized communication between an existing subscriber and a new subscriber referred by the existing subscriber.

Operations performed in connection with such a scenario are illustrated in FIG. 7. As shown in FIG. 7, operations begin at 705 and control proceeds to 710, at which a referral of a potential subscriber is received from an existing mobile service subscriber. Control then proceeds to 715, at which an offer for services is transmitted to the potential subscriber. Control then proceeds to 720, at which an indication of the acceptance of the offer by the referred person is received. Subsequently, at 725, a new Subscriber Identity Module (SIM) card is sent to the new subscriber as part of provisioning of the mobile service for the new subscriber. At 730, a communication is sent to the referring subscriber including contact information for the new subscriber. For example, the communication may include a new contact card with the new subscriber's name and new (or old) contact information (e.g., phone number) as well as an indication that the referring subscriber may initiate communication (e.g., voice calls, messaging, video phone, e-mail, etc.) at no or at a reduced cost in return for the successful referral of the new subscriber. Such a message may be sent, for example, via the SMSC 40 illustrated in FIG. 1. Alternately, or in addition, this message or its content could be inserted in a business card, e.g., such as a vCard. Additionally, an graphic or icon (e.g., icon 525 illustrated in FIG. 5) could also be included with this content (see, for example, RFC 2426 for PHOTO attribute).

Control then proceeds to 735, at which the referring subscriber's contact card is sent to the new subscriber with a similar graphic or icon indicating free or subsidized communication. Thus, next time the referring subscriber want to communicate with the new subscriber, a search of the enhanced contact directory will display a listed of the contact with the graphic or icon indicating free or subsidized communication.

Control then proceeds to 740, at which pricing rules are updated to reflect the pricing available to the referring and new subscribers. Control then proceeds to 745 at which the operations performed in connection with the referral promotion end.

It should be appreciated that the referral promotion may provide free communication between the referring subscriber and the new subscriber for only a specified period of time, using only one communication mode (e.g., messaging but not voice calls), or be limited for only communication that remains within the communication network(s) under the control or associated with the mobile service provider offering the referral promotion.

Subsequent, to the operations performed in FIG. 7, an indication that the new subscriber may be communicated with for free may be included with the contact entry associated with the new subscriber in the enhanced contact directory. For example, with reference to FIG. 5, an graphic or icon 525 associated with the promotion, the mobile service provider and/or the label “FREE” may be included in the enhanced contact directory in association with the contact entry.

It should be appreciated that various different alternative operations may be performed to populate the enhanced telephone directory with contact information. For example, the enhanced telephone directory may be populated with contact information by a user inputting information into the user interface. Alternatively, or in addition, contact information may be obtained in whole or in part from one or more mobile services, e.g., a caller identification service, also known as “caller ID.” Caller ID enables the called party to identify the calling party prior to accepting the call. Caller ID is available for many mobile services and is also possible even when a calling party uses a different mobile service provider or is on a different network than the called party. Using caller ID, the telephone number of the calling party is displayed on the user interface so that the called party can determine whether to accept the call.

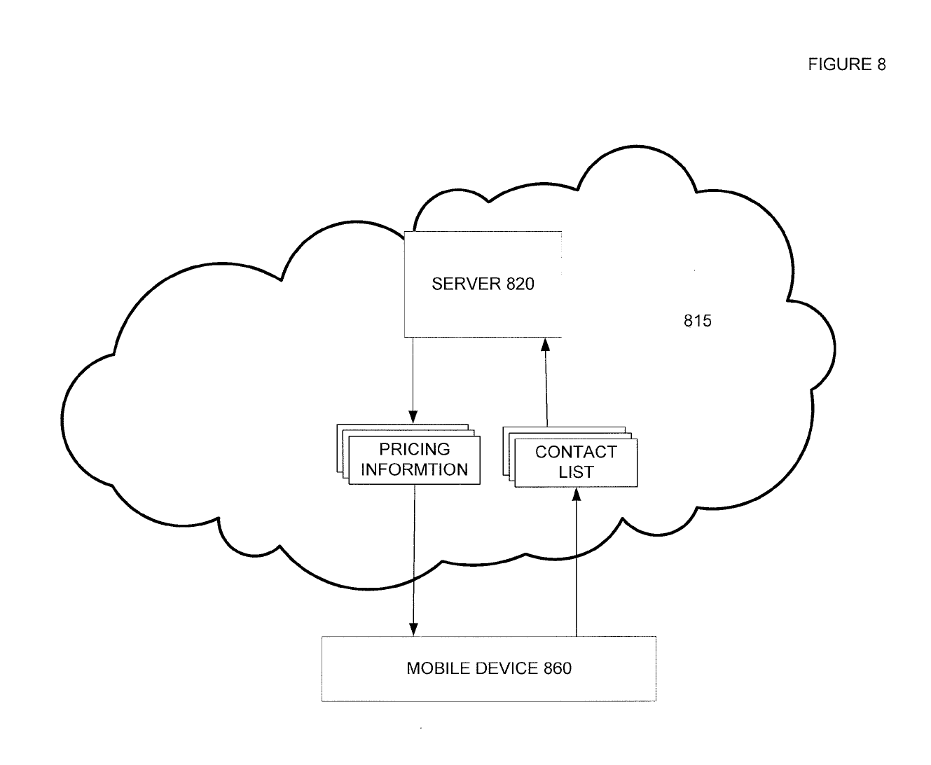

Further, as illustrated in FIG. 8, a subscriber may also transmit, download, or request review of some or all of the contacts listed in the contact directory of his mobile device 860 to a server 820 over a public network 815. Accordingly, server 820 may reply to the subscriber's query by providing pricing information, potentially including which contacts may be communicated with for free or potentially for free (e.g., if an advertiser or advertising campaign offers to sponsor communication). Thus, the server 820 may be associated with or managed by a mobile service provider and/or managed by an advertiser (e.g., using an advertisement amanagement system 10 as illustrated in FIG. 1), or managed and/or operated in conjunction with a community building service, e.g., Facebook™ or MySpace™.

It should also be appreciated that various different operations may be performed to update pricing information provided in the enhanced contact directory. Fore example, the enhanced contact directory application may communicate with the UCS to check pricing of each or some of the contacts, for example, periodically, randomly, after, before or during a communication with a contact. Further, such updating may be performed in response to a user roaming out of their home network (and thereby likely altering the cost of communicating using their mobile device.

Further, the UCS may transmit updated pricing data to a mobile device as needed, for example, when the mobile device requests an update, a network-wide pricing change has occurred or an advertiser is subsidizing or assuming responsibility for communication charges of a particular type, for a particular time or to particular contacts as part of an advertising campaign.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that the term “promotional material” is meant to include any one of or combination of text, pictures, audio, video, links to web-sites or other locations of information, telephone numbers, electronic mail addresses, downloadable files including but not limited to audio files including ring tones, songs, etc, computer implemented games, video files, etc.

Further, it should be understood that information indicating how much network resources a communication, e.g., voice call, from a mobile service subscriber to a contact will or is likely to require may be provided as part of the mobile service subscriber's enhanced contact directory and/or displayed on various other operation screens provided by software included in the subscriber's mobile device. Accordingly, such information may be included in call history listings, on an idle screen, e.g., the screen displayed when the user is not interacting with the mobile device, etc. For example, price data or predicted price data may be displayed on an idle screen in a way similar to the way signal strength or battery levels are indicated. Therefore, a general price level indicator may be displayed on the idle screen and could be set either remotely or calculated by the enhance contact directory application on the mobile device. Calculation of that general price level indicator may be based on price data for one or more of contact rectory call pairs to determine the likely statistical remaining communication time or resources available via the mobile device. For example, the general price level may be formulated or predicted using call history data to determine the likelihood of contacting listed contacts and durations of communications and calculate a weighted average of remaining talk time based on a remaining credit available to the user.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Further, it should be understood that the UCS may send a mobile services subscriber a message indicating that an advertiser has offered to pay for a previous communication between the subscriber and a contact included in the subscriber's contact directory as well as future communications with that contact in return for the subscriber's allowing the advertiser's promotional material to be included in communications with that contact and/or other contacts.

Various components of the invention may be provided in alternative combinations operated by, under the control of or on the behalf of advertisers, advertising channel provider(s), network providers, marketing organizations, etc.

Further, it should be understood that, in accordance with at least one embodiment of the invention, system components may be implemented together or separately and there may be one or more of any or all of the disclosed system components. For example, the UCS functionality and/or components may be provided by equipment and/or software operated by an advertisement operator and/or equipment and/or software operated and/or controlled by an advertiser. Further, one or more advertisers may use, control or communicate with UCS components directly without communicating with the AMS.

Additionally, UCS system components may be either dedicated systems receiving information from the AMS or such functionality may be implemented as virtual systems implemented on general purpose equipment via software implementations.

As a result, it will be apparent for those skilled in the art that the illustrative embodiments described are only examples and that various modifications can be made within the scope of the invention as defined in the appended claims.

1. An enhanced contact directory application for installation configured to provide an enhanced contact directory for display on a mobile device, the enhanced contact directory comprising: contact information entries associated with contacts listed in the enhanced contact directory, the contact information including information required to communicate with the contact via the mobile device; and pricing information indicating a cost or likely cost of subsequent communication with the contact via the mobile device, wherein, the enhanced contact directory application is stored in whole or in part in memory of the mobile device.

2. The enhanced contact directory application of claim 1, wherein the pricing information includes at least one icon indicating a sponsor of subsequent communication with the contact via the mobile device.

3. The enhanced contact directory application of claim 1, wherein the pricing information includes an indication of whether subsequent communication with the contact via the mobile device is free.

4. The enhanced contact directory application of claim 1 claim 1, wherein the pricing information is updated by a universal charge system included in a communication network accessed by the mobile device to communicate with the contact.

5. The enhanced contact directory application of claim 1, wherein the pricing information is updated periodically under the control of a universal charge system included in a communication network accessed by the mobile device to communicate with the contact.

6. The enhanced contact directory application of claim 1, wherein the pricing information is updated by communicating with a universal charge system included in a communication network accessed by the mobile device to communicate with the contact.

7. The enhanced contact directory application of claim 6, wherein the pricing information is updated in response to a request of the user of the mobile device transmitted from to the universal charge system via the mobile device.

8. The enhanced contact directory application of claim 1, wherein the contact information includes information required to communicate with the contact via a plurality of communication modes.

9. The enhanced contact directory application of claim 8, wherein the communication modes include voice call and electronic mail.

10. The enhanced contact directory application of claim 1, wherein the pricing information includes information indicating the cost or likely cost of subsequently communicating with the contact both while the mobile device is in a home location network of the mobile device and out of the home location network of the mobile device.

11. An enhanced contact directory output on a display of a mobile device, the enhanced contact directory comprising: contact information entries associated with contacts listed in the enhanced contact directory, the contact information including information required to communicate with the contact via the mobile device; and pricing information indicating a cost or likely cost of subsequent communication with the contact via the mobile device, wherein, the enhanced contact directory is output on a display of a mobile device and enables selection of a contact and selection of a communication mode for communicating with the selected contact via a user interface included in the mobile device.

12. The enhanced contact directory of claim 11, wherein the pricing information includes at least one icon indicating a sponsor of communication with the contact via the mobile device.

13. The enhanced contact directory of claim 11, wherein the pricing information includes an indication of whether communication with the contact via the mobile device is free.

14. The enhanced contact directory of claim 11, wherein the pricing information is updated by a universal charge system included in a communication network accessed by the mobile device to communicate with the contact.

15. The enhanced contact directory of claim 11, wherein the pricing information is updated periodically under the control of a universal charge system included in a communication network accessed by the mobile device to communicate with the contact.

16. The enhanced contact directory of claim 11, wherein the pricing information is updated by communicating with a universal charge system included in a communication network accessed by the mobile device to communicate with the contact.

17. The enhanced contact directory of claim 16, wherein the pricing information is updated in response to a request of the user of the mobile device transmitted from to the universal charge system via the mobile device.

18. The enhanced contact directory of claim 11, wherein the contact information includes information required to communicate with the contact via a plurality of communication modes.

19. The enhanced contact directory of claim 18, wherein the communication modes include voice call and electronic mail.

20. The enhanced contact directory of claim 11, wherein the pricing information includes information indicating the cost or likely cost of communicating with the contact both while the mobile device is in a home location network of the mobile device and out of the home location network of the mobile device.

21. A method for updating an enhanced contact directory provided in a mobile device with communication pricing information associated with one or more contacts included in the enhanced contact directory, the method comprising: sending a contact information message to a mobile device of a first mobile services subscriber, the contact information message including contact information for a second mobile services subscriber; wherein the contact information message sent to the first mobile services subscriber includes pricing information indicating a cost or the likely cost of subsequent communication with the second mobile services subscriber via the first mobile services subscriber's mobile device.

22. The method of claim 21, further comprising sending a contact information message including contact information for the first mobile services subscriber to a mobile device of the second mobile services subscriber, wherein, the contact information message sent to the second mobile services subscriber includes pricing information indicating a cost or the likely cost of subsequent communication with the first mobile services subscriber via the second mobile services subscriber's mobile device.

23. The method of claim 22, wherein the contact information message is sent via a text message.

24. The method of claim 22, wherein the contact information message includes a vCard.

25. The method of claim 22, wherein the pricing information sent to the second subscriber is stored in the enhanced contact directory resident in the second subscriber's mobile device.

26. The method of claim 22, wherein the pricing information includes an icon indicating an identity of an advertiser sponsoring subsequent communication between the second mobile services subscriber and the first mobile services subscriber.

27. The method of claim 21, wherein the contact information message is sent via a text message.

28. The method of claim 21, wherein the contact information message includes a vCard.

29. The method of claim 21, further comprising receiving contact information for the second mobile services subscriber as part of a referral from the first mobile service subscriber and sending the second mobile services subscriber an offer for mobile services.

30. The method of claim 29, further comprising receiving an acceptance of the mobile services offer from the second mobile services subscriber and sending a subscriber identity module to the second mobile service subscriber as part of provisioning mobile service for the second mobile services subscriber.

31. The method of claim 21, wherein the pricing information sent to the first subscriber is stored in the enhanced contact directory resident in the first subscriber's mobile device.

32. The method of claim 21, wherein the pricing information includes an icon indicating an identity of an advertiser sponsoring communication between the first mobile services subscriber and the second mobile services subscriber.

33. A component provided in a mobile network providing mobile services to a plurality of mobile service subscribers, the component being configured to charge an advertiser for at least some portion of a cost associated with a communication from a mobile services subscriber to a contact listed in an enhanced contact directory resident in the mobile services subscriber's mobile device.

34. The component of claim 33, wherein the component is further configured to send a mobile services subscriber a message indicating that an advertiser has offered to pay for a previous communication between the subscriber and a contact included in the subscriber's contact directory as well as future communications with that contact in return for the subscriber's allowing the advertiser's promotional material to be included in communications with that contact.

35. A method for providing no cost or reduced cost communication services to a mobile device including an enhanced contact directory that includes communication pricing information associated with one or more contacts included in the enhanced contact directory, the method comprising: processing a request to access contact information in a mobile device of a first mobile services subscriber, the contact information being included in the enhanced contact directory and including contact information for a second mobile services subscriber; and processing a request to communicate with the second mobile services subscriber via the mobile device of the first mobile services subscriber, wherein the contact information included in the enhanced contact directory includes pricing information indicating a cost or the likely cost of subsequent communication with the second mobile services subscriber via the first mobile services subscriber's mobile device and communication is supported between the first and second mobile services subscribers in accordance with the indicated cost or likely cost included in the pricing information.

36. A method for updating a contact information, the method comprising: receiving contact information relating to a second user from a first user; monitoring if the second user accesses or subscribes to a mobile service; and sending updated contact information including pricing information specific to communication between the first and second user to the first user's mobile device.

37. The method of claim 36, wherein the receiving, monitoring and sending operations are performed by a server coupled to a network communicating with a mobile device of the first user.

38. The method of claim 36, wherein the contact information includes at least one of a phone number, address, electronic mail address, or network ID.

39. The method of claim 36, wherein the monitoring is performed in conjunction with an advertising campaign, which the second subscriber may opt into to subscribe to the mobile service.

40. The method of claim 36, wherein the updated contact information includes an indicator that indicates the pricing of communication between the first and second users.

41. A system for supporting provision of no cost or reduced cost communication services to a mobile device including an enhanced contact directory that includes communication pricing information associated with one or more contacts included in the enhanced contact directory, the method comprising: a server; a control program running on the server; a first contact directory application configured to upload contact information from a terminal to the server; and a second contact directory application configured to receive contact information from the server, wherein the contact information received from the server includes pricing information specific to subsequent communication with at least one contact included in the contact directory.

42. The system of claim 41, wherein the second contact directory application is configured to use the contact information received from the server or to modify the enhanced contact directory to include the received information.

43. The system of claim 41, wherein the second contact directory application is configured to update pricing information in the enhanced contact directory based on at least one of time and roaming information.
